(19) United States
(12) Patent Application Publication
(10) Pub. No.: US 2024/0281887 A1
(43) Pub. Date: Aug. 22, 2024

(54) PREDICTING REIMBURSEMENT FOR HEALTHCARE SERVICES

(71) Applicant: Cerner Innovation, Inc., Kansas City, MO (US)

(72) Inventors: Monica Gaur, Delhi (IN); Suman Pal, Bangalore (IN); Rupanjali Chaudhuri, Bangalore (IN); Oshin Benny Anto, Kerala (IN); Kalaivanan R, Bangalore (IN); Andrew Roberts, Overland, KS (US)

(73) Assignee: Cerner Innovation, Inc., Kansas City, MO (US)

(21) Appl. No.: 18/192,099

(22) Filed: Mar. 29, 2023

Related U.S. Application Data
(60) Provisional application No. 63/446,743, filed on Feb. 17, 2023.

(51) Int. Cl. G06Q 40/08

(52) U.S. Cl. CPC G06Q 40/08

(57) ABSTRACT

Techniques for predicting, by a machine learning model, reimbursement characteristics associated with healthcare services are disclosed. A system trains a machine learning model to estimate characteristics of a predicted reimbursement associated with a healthcare service. The predicted reimbursement may be generated by applying the trained machine learning model to healthcare services data prior to the generation of medical claims, or subsequent to the generation of medical claims. The system generates recommendations for modifying one or more of healthcare services, recorded descriptions of healthcare services, and medical claims based on the healthcare services in response to the machine learning model predictions.

### INCORPORATION BY REFERENCE; DISCLAIMER

The following application is hereby incorporated by reference: application No. 63/446,743 filed on Feb. 17, 2023. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to applying a machine learning model to healthcare services data to predict reimbursement values associated with the healthcare services, some predictions being made prior to generation of insurance claims for the healthcare services. In particular, the present disclosure relates to generating recommendations for modifying one or both of healthcare services and healthcare service descriptions to improve reimbursement values for the healthcare services.

### BACKGROUND

Medical providers bill insurance providers and patients for medical services provided by the medical providers. Frequently, insurers reimburse the medical provider less than an amount requested in a medical claim. The reimbursement amount may be less than the actual cost of providing the medical services. Underpayment of medical providers threatens access to healthcare for many communities.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates a set of operations for generating recommendations for modifying healthcare services submission data in accordance with one or more embodiments;

FIG. 3 illustrates an example set of operations for training a machine learning model to estimate unknown labels for expense data in accordance with one or more embodiments;

FIG. 4 illustrates an example embodiment; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. ARCHITECTURAL OVERVIEW
3. GENERATING RECOMMENDATIONS FOR MODIFYING HEALTHCARE SERVICES ATTRIBUTES
4. INTEGRATING MACHINE LEARNING INTO MODIFICATIONS TO HEALTHCARE SERVICES
5. EXAMPLE EMBODIMENT
6. HARDWARE OVERVIEW
7. COMPUTER NETWORKS AND CLOUD NETWORKS
8. MICROSERVICE APPLICATIONS
9. MISCELLANEOUS; EXTENSIONS

### 1. General Overview

One or more embodiments apply a machine learning model to healthcare services data for a healthcare service, prior to generating a claim for the healthcare service, to improve reimbursement outcomes associated with healthcare services. A system trains a machine learning model to estimate characteristics of a predicted reimbursement associated with healthcare services. The system trains the model with a set of labeled healthcare services data. The healthcare services data may be obtained from multiple stages of healthcare services—from a patient check-in to a medical claim submission to a reimbursement entity for obtaining reimbursement. For example, a set of labeled healthcare services data may include: information obtained from a check-in terminal when a patient first arrives at a healthcare facility, healthcare services performed, prescriptions written, medical coding generated associated with the healthcare services, monetary charges generated associated with the healthcare services, and/or medical claim entries.

One or more embodiments apply a machine learning model to healthcare services data that is not used to generate a medical claim, or that is not included in a medical claim. Examples of information collected by a healthcare provider that may not be used to generate a medical claim, or that is not included in a medical claim, includes: sensitive information, such as information about a patient's mental health, sexual history, substance abuse, or family physical or mental health history; genetic test results; psychotherapy notes; and diagnoses associated with sensitive information. According to one example, a mental health practitioner may prescribe medication to a patient based on a mental health diagnosis. The practitioner may record information about the patient's mental health that is not included in a claim to be provided to a reimbursement entity. A machine learning model may analyze the information that is not included in a medical claim and identify alternative language—omitting a description of sensitive patient information associated with the patient's mental health—that could be included in a claim to describe the healthcare services that would increase a reimbursement outcome for the treatment.

One or more embodiments generate recommendations for modifying one or both of healthcare services and medical claim data associated with the healthcare services to improve reimbursement outcomes for the medical services. For example, the machine learning model may identify a particular type of data that may be collected when a user checks in that increases reimbursement outcomes. According to one example, promptly taking a patient's temperature and blood pressure when the patient checks in may result in an improved reimbursement outcome associated with a particular insurer. As another example, when two treatment options are available for a particular patient, the machine learning model may identify one of the treatment options as corresponding to a better reimbursement outcome. According to yet another example, the machine learning model may recommend adding, removing, or changing a medical code associated with a particular healthcare service or administered drug. According to one example, a particular healthcare service may be associated with two or more medical codes. A medical claim describing the healthcare service may list two separate medical codes associated with the healthcare service. The machine learning model may be trained to identify a relationship between the combined set of codes and a sub-optimal reimbursement result, such as a delayed reimbursement or a reimbursement of a lower amount. Accordingly, the machine learning model may generate a label recommending omitting one of the medical codes to obtain one or both of a greater reimbursement or a reimbursement received more promptly.

In an embodiment, the machine learning model may monitor healthcare services in real-time and generate recommendations in real-time. For example, the machine learning model may identify patient check-in information to identify recommendations for a practitioner checking in a patient to collect additional information or perform additional check-in procedures to improve a reimbursement outcome. A healthcare services platform may generate a notification in a user terminal to prompt the practitioner to modify the check-in procedure. As another example, a doctor or nurse may record a particular diagnosis upon meeting with a patient. A healthcare services platform may generate a prompt indicating a course of treatment associated with the diagnosis that corresponds to an improved reimbursement outcome. For example, there may be two drugs available to treat a diagnosed medical condition. The two drugs may have similar treatment outcomes. However, one of the drugs may have a better reimbursement outcome. The healthcare services platform may identify the two drugs and generate a notification indicating the drug with the better reimbursement outcome.

According to another example, the machine learning model may recommend modifying a monetary value associated with a particular healthcare service or administered drug. A healthcare provider responsible for generating charges for medical services may enter a relatively high monetary value associated with a healthcare service. The machine learning model may be trained to identify a relationship between the relatively high monetary value and a sub-optimal reimbursement result, such as a denial of the reimbursement or a reimbursement of a lower amount. Accordingly, the machine learning model may generate a label recommending reducing the monetary value associated with the healthcare service to obtain one or both of a greater reimbursement amount or greater likelihood of receiving a reimbursement. For example, reducing a monetary value associated with a healthcare service may include omitting from a reimbursement request information (such as a description of a service) that was previously included. Alternatively, reducing the monetary value associated with the healthcare service may include combining services described on two separate lines of a reimbursement request into a single line associated with a single charge. A healthcare service platform may generate a prompt for the healthcare provider to reduce the charge associated with the healthcare service to improve the reimbursement outcome.

In an embodiment, the machine learning model generates a recommended priority value for a set of data associated with healthcare services for a particular patient. Among a set of hundreds or thousands of healthcare services, a medical services provider may set a business policy of submitting and pursuing claims associated with a higher priority, which may correspond, for example, to a higher likelihood of receiving a reimbursement and a higher likelihood that a received reimbursement will compensate the healthcare provider for the services provided and the cost to pursue the medical claim. In addition, or in the alternative, a priority value may be associated with a time constraint for submitting a medical claim. For example, a medical claim for which a period for requesting a reimbursement is soon to expire may be associated with a higher priority value than another medical claim. Accordingly, a system may train a machine learning model on a training data set of medical claims labeled with reimbursement values and priority values. The system applies the machine learning model to medical claim data to generate a set of medical claims and corresponding priority values. The healthcare provider initiates operations for obtaining reimbursements for healthcare services according to the priority values. For example, the healthcare provider may submit a particular number of medical claims having the highest priority value to a particular insurer within a specified time period.

One or more embodiments described in this Specification and/or recited in the claims may not be included in this General Overview section.

### 2. Architectural Overview

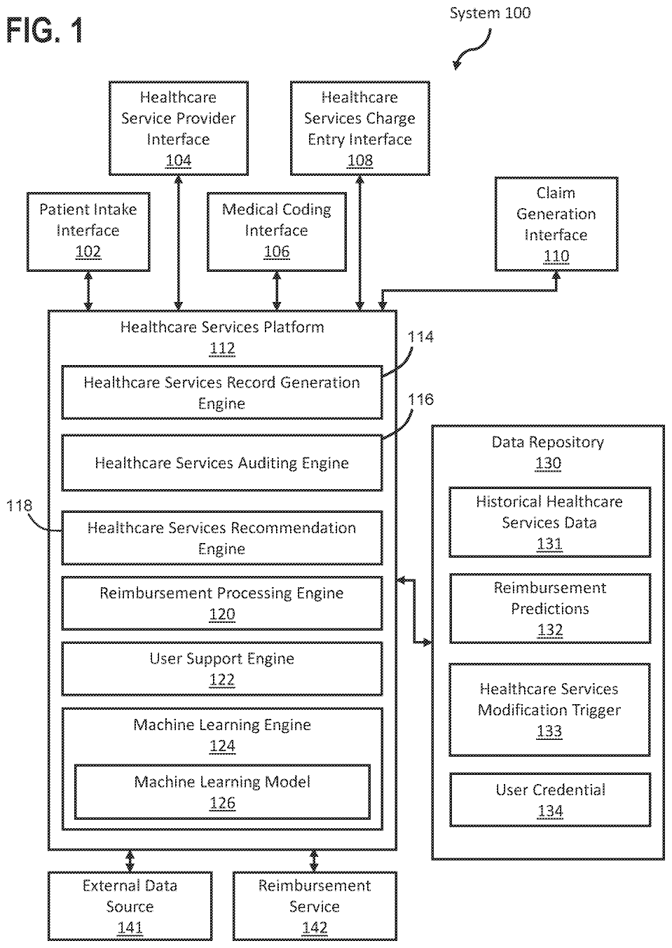

FIG. 1 illustrates a system 100 in accordance with one or more embodiments. As illustrated in FIG. 1, system 100 includes a patient intake interface 102, a healthcare service provider interface 104, a medical coding interface 106, a healthcare services charge entry interface 108, and a claim generation interface 110, a healthcare services platform 112, a data repository 130, an external data source 141, and a reimbursement service 142. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below.

In some embodiments, each of patient intake interface 102, a healthcare service provider interface 104, a medical coding interface 106, a healthcare services charge entry interface 108, and a claim generation interface 110 refers to hardware and/or software configured to facilitate communications between a user and a healthcare services platform 112. Devices may include, for example, a computer terminal or handheld computing tablet, or any other kind of device configured to record data about a performed healthcare service. A submitter interface 102 may be used by a user, such as an employee, who is responsible for preparing and submitting descriptions of healthcare services provided to a patient. The patient intake interface 102 may be associated with one or more devices for obtaining patient information when a patient registers with and/or arrives at a healthcare services facility. The patient intake interface 102 may receive and store patient attributes including patient symptoms, patient health history, insurance information, contact information, a date and time that the patient or provider entered the information, and a location where the information was entered. Additional patient attributes may include attributes obtained from a healthcare provider prior to the patient seeing a doctors, such as patient vitals (e.g., temperature, visual symptoms, blood pressure).

A healthcare service provider interface 104 may be used by a user, such as a doctor, nurse, or medical assistant, who is responsible for diagnosing and treating a patient, or for recording a physician's diagnosis, treatment, and/or prescribed treatment of the patient. A medical coding interface 106 refers to a terminal used by an employee to associated medical codes with a diagnosis, treatment, and/or prescribed treatment of a patient. A healthcare services charge entry interface 108 refers to a terminal used by an employee to associated monetary charge value with a diagnosis, treatment, and/or prescribed treatment of a patient. A claim generation interface 110 refers to a terminal or application that generates a medical claim to submit to a reimbursement entity associated with the diagnosis, treatment, and/or prescribed treatment of the patient. A reimbursement entity is an entity that reimburses a portion or all costs specified in a medical claim. A reimbursement entity may be an insurance company or a patient. For example, when an insurance company denies a medical claim or pays only a portion of the claim, a patient may be required to pay the remainder. One or more of the patient intake interface 102, a healthcare service provider interface 104, a medical coding interface 106, a healthcare services charge entry interface 108, and a claim generation interface 110 may be the same interface. A user may have multiple roles corresponding to obtaining patient intake information, providing healthcare services, assigning medical codes to treatment and/or prescribed treatments, assigning charges to healthcare services, and generating a claim to submit to a reimbursement entity. For example, an employee who obtains patient vitals via a patient intake interface 102 may also perform medical coding and charge entry.

In some embodiments, a user interface (e.g., patient intake interface 102, a healthcare service provider interface 104, a medical coding interface 106, a healthcare services charge entry interface 108, and a claim generation interface 110) renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In some embodiments, different components of a user interface (e.g., patient intake interface 102, a healthcare service provider interface 104, a medical coding interface 106, a healthcare services charge entry interface 108, and a claim generation interface 110) are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, a user interface may be specified in one or more other languages, such as Java, C, or C++.

In some embodiments, a healthcare services platform 112 includes a healthcare services record generation engine 114. A healthcare services record generation engine 114 refers to hardware and/or software configured to perform operations described herein (including such operations as may be incorporated by reference) for recording data associated with healthcare services provided by a healthcare services provider, such as a doctor, nurse, a hospital, or other medical facility, group, or organization. The data associated with the healthcare services may include any data associated with a patient, from a patient setting an appointment or patient data obtained at intake, to diagnosis and treatment, to classifying healthcare services with medical codes, to generated monetary charge values for the healthcare services, to generating claim entries for the medical services.

In some embodiments, a healthcare services platform 112 includes a healthcare services auditing engine 116. The healthcare services auditing engine 116 refers to hardware and/or software configured to perform operations described herein (including such operations as may be incorporated by reference) for auditing healthcare services and/or records associated with the healthcare services prior to submitting the claims to a patient and/or insurance provider.

In some embodiments, a healthcare services platform 112 includes a healthcare services recommendation engine 118. A healthcare services recommendation engine 118 refers to hardware and/or software configured to perform operations described herein (including such operations as may be incorporated by reference) for recommending particular modifications to healthcare services, recorded descriptions of healthcare services, medical codes associated with healthcare services, and/or claim content associated with the healthcare services.

In some embodiments, a healthcare services platform 112 includes a reimbursement processing engine 120. A reimbursement processing engine 120 refers to hardware and/or software configured to perform operations described herein (including such operations as may be incorporated by reference) for processing reimbursements from reimbursement providers, such as insurance companies, resulting from healthcare service claims submitted to the reimbursement providers.

In some embodiments, a healthcare services platform 112 includes a user support engine 122. A user support engine 122 refers to hardware and/or software configured to perform operations described herein (including such operations as may be incorporated by reference) for processing and responding to user queries submitted to the healthcare services platform 112.

In some embodiments, one or more components of the expense reporting service use a machine learning engine 124. Machine learning includes various techniques in the field of artificial intelligence that deal with computer-implemented, user-independent processes for solving problems that have variable inputs.

In some embodiments, the machine learning engine 124 trains a machine learning model 126 to perform one or more operations for predicting reimbursements associated with medical services and/or for recommending modifications to medical services. Training a machine learning model 126 uses training data to generate a function that, given one or more inputs to the machine learning model 126, computes a corresponding output. The output may correspond to a prediction based on prior machine learning. In some embodiments, the output includes a label, classification, and/or categorization assigned to the provided input(s). The machine learning model 126 corresponds to a learned model for performing the desired operation(s) (e.g., labeling, classifying, and/or categorizing inputs). A healthcare services platform 112 may use multiple machine learning engines 124 and/or multiple machine learning models 126 for different purposes.

In some embodiments, the machine learning engine 124 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 124 receives positive and/or negative reinforcement in the process of attempting to solve a particular problem (e.g., to improve reimbursements for healthcare services and corresponding medical claims). In some embodiments, the machine learning engine 124 initially uses supervised learning to train the machine learning model 126 and then uses unsupervised learning to update the machine learning model 126 on an ongoing basis.

In some embodiments, a machine learning engine 124 may use many different techniques to label, classify, and/or categorize inputs. A machine learning engine 124 may transform inputs into feature vectors that describe one or more properties (“features”) of the inputs. The machine learning engine 124 may label, classify, and/or categorize the inputs based on the feature vectors. Alternatively, or additionally, a machine learning engine 124 may use clustering (also referred to as cluster analysis) to identify commonalities in the inputs. The machine learning engine 124 may group (i.e., cluster) the inputs based on those commonalities. The machine learning engine 124 may use hierarchical clustering, k-means clustering, and/or another clustering method or combination thereof. In some embodiments, a machine learning engine 124 includes an artificial neural network. An artificial neural network includes multiple nodes (also referred to as artificial neurons) and edges between nodes. Edges may be associated with corresponding weights that represent the strengths of connections between nodes, which the machine learning engine 124 adjusts as machine learning proceeds. Alternatively, or additionally, a machine learning engine 124 may include a support vector machine. A support vector machine represents inputs as vectors. The machine learning engine 124 may label, classify, and/or categorizes inputs based on the vectors. The coordinates of the vectors and corresponding boundaries between different hyperplanes may be adjusted as machine learning proceeds. Alternatively, or additionally, the machine learning engine 124 may use a naïve Bayes classifier to label, classify, and/or categorize inputs. Alternatively, or additionally, given a particular input, a machine learning model may apply a decision tree to predict an output for the given input. Alternatively, or additionally, a machine learning engine 124 may apply fuzzy logic in situations where labeling, classifying, and/or categorizing an input among a fixed set of mutually exclusive options is impossible or impractical. The aforementioned machine learning model 126 and techniques are discussed for exemplary purposes only and should not be construed as limiting one or more embodiments.

In some embodiments, as a machine learning engine 124 applies different inputs to a machine learning model 126, the corresponding outputs are not always accurate. As an example, the machine learning engine 124 may use supervised learning to train a machine learning model 126. After training the machine learning model 126, if a subsequent input is identical to an input that was included in labeled training data and the output is identical to the supervisory signal in the training data, then output is certain to be accurate. If an input is different from inputs that were included in labeled training data, then the machine learning engine 124 may generate a corresponding output that is inaccurate or of uncertain accuracy. In addition to producing a particular output for a given input, the machine learning engine 124 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In some embodiments, a data repository 130 is any type of storage unit and/or device (e.g., a file system, database, collection of tables, or any other storage mechanism) for storing data. Further, a data repository 130 may include multiple different storage units and/or devices. The multiple different storage units and/or devices may or may not be of the same type or located at the same physical site. Further, a data repository 130 may be implemented or may execute on the same computing system as one or more other components of the system 100. Alternatively, or additionally, a data repository 130 may be implemented or executed on a computing system separate from one or more other components of the system 100. A data repository 130 may be communicatively coupled to one or more other components of the system 100 via a direct connection or via a network.

In some embodiments, a data repository 130 is configured to store historical healthcare services data 131. Historical healthcare services data 131 may include any kind of data that the healthcare services platform 112 has previously received and/or generated in association with healthcare services provided and corresponding claims for medical services. Specifically, the historical healthcare services data 131 may include medical services descriptions, data associated with reimbursements from insurers, such as reasons provided from insurers for denying claims or providing a reimbursement less than a claim amount, and/or any other kind of data or combination thereof associated with claims for medical services.

In some embodiments, the data repository 130 stores reimbursement predictions 132 generated by a machine learning model 126. In some embodiments, the data repository 130 stores one or more healthcare services modification triggers 133. A healthcare services modification trigger 133 is a codified set of rules and/or a set of automatically learned patterns that captures one or more conditions for identifying healthcare services, or stored data associated with healthcare services. A healthcare service identified by a healthcare services modification trigger 133 may be a healthcare service associated with particular criteria, including: a date when data was entered associated with a healthcare service, a time when time between when a medical service was provided and when a claim was generated or processed for submission to an insurer, an amount of a claim, a type of medical service included in a claim, a number of separate healthcare services included within one medical claim form, and an identify of an insurer to which the claim is to be directed.

Many different kinds of healthcare services modification triggers 133 may be defined. In an embodiment, a healthcare services platform 112 uses a machine learning engine 124 to determine a healthcare services modification trigger 133 as part of a machine learning model 126. Machine learning engine 124 is able to automatically infer healthcare services recommendation triggers 133 even though the exact pattern may not have been seen before. Further, machine learning engine 124 is able to learn different patterns of behavior that qualify as a healthcare services modification trigger 133 depending on context.

In some embodiments, a healthcare services modification trigger 133 is based, at least in part, on a determination that one healthcare service is more likely to be reimbursable than another healthcare service. For example, one healthcare service may have an older initiation date than another. The older healthcare service may be associated with a lower reimbursement value. The healthcare services modification trigger 133 may identify the healthcare services for applying a machine learning model to healthcare services data to generate a recommendation for generating medical claims for one or more healthcare services. The machine learning model 126 may recommend prioritizing the generating medical claims for particular healthcare services based on the predicted reimbursement values of the healthcare services.

In some embodiments, a healthcare services modification trigger 133 is based, at least in part, on a determination that a healthcare service is associated with a particular classification code. For example, a healthcare service may be associated with two or more classification codes. One classification code may be associated with a higher reimbursement amount than another classification code. The healthcare services modification trigger 133 may identify a particular classification code as a trigger for applying a machine learning model to healthcare services data to generate a recommendation for one or more healthcare services. The machine learning model 126 may generate a recommendation to assign a particular classification code to the healthcare service.

In some embodiments, a healthcare services modification trigger 133 is based, at least in part, on the passage of a predetermined period of time. For example, a healthcare services platform 112 may compile a batch of medical claims generated each day and apply a machine learning model to the batch of medical claims to generate recommendations for modifying medical claim submission data associated with the medical claims.

In some embodiments, medical healthcare services modification trigger 133 is based, at least in part, on an identity of an insurer associated with a patient receiving healthcare services. Different insurers may have different reimbursement rates for different types of healthcare services, for different delays between medical services and claim submission, and for different healthcare codes assigned to medical services. A machine learning model may generate a recommendation to modify healthcare service data associated with one insurer to include one code or set of codes associated with a healthcare service. The machine learning model may generate a recommendation to modify the healthcare service data associated with another insurer to include a different code or set of codes associated with the same healthcare service. In addition, or in the alternative, a machine learning model may generate a recommendation to modify healthcare service data associated with one insurer to assign a first priority level to a healthcare service. The machine learning model may generate a recommendation to modify the healthcare service data associated with another insurer to assign a second priority level to the same healthcare service.

In some embodiments, a healthcare services modification trigger 133 is based, at least in part, on a charge limit for a particular healthcare service and/or a particular patient. For example, the healthcare services modification trigger 133 may specify a particular monetary value associated with a particular healthcare service or set of services. The particular monetary value may be a value that has been identified as being significant, historically, to a value of a reimbursement received for a medical claim.

In some embodiments, a healthcare services modification trigger 133 is based, at least in part, on information about employees who are associated with a healthcare service. For example, a healthcare services modification trigger 133 may identify a doctor, a group of doctors, a surgeon, a nurse, or a medical assistant as an employee or type of employee as being significant, historically, to a value of a reimbursement received for a medical claim associated with a healthcare service. The healthcare services modification trigger 133 may identify a particular doctor (e.g., “Dr. Smith”) as being a trigger. Alternatively, or in addition, the healthcare services modification trigger 133 may identify a type of medical services provider (e.g., a general practitioner, a medical resident, a surgeon, a medical assistant, or a specialist, such as an oncologist, an anesthesiologist, an optometrist) as being a trigger.

In some embodiments, a data repository 130 is configured to store one or more user credentials 134. A healthcare services platform 112 may use a user credential 134 to access an external data source 141 and obtain data from the external data source 141. A user credential 134 may include a username, user identifier (ID), password, private key, public key, and/or any other kind of credential or combination thereof. In some embodiments, an employee supplies a user credential 134 to a healthcare services platform 112 via a graphical user interface. For example, the healthcare services platform 112 may use three-party authentication to obtain a user credential 134 from an employee.

In some embodiments, user data that is input into machine learning engine 124 is anonymized. Personal identifying information (PII) and other sensitive information may be replaced with an anonymous identifier, such as a cryptographic hash of the user data. Machine learning engine 124 may use the anonymized data to learn patterns and make predictions for different medical claims, within the same or different organizations, having similar attributes without compromising or revealing sensitive employee and/or patient data.

Information describing one or more components that are illustrated here within a data repository 130 may be implemented across any of components within the system 100. However, this information is illustrated within the data repository 130 for purposes of clarity and explanation.

In some embodiments, a healthcare services platform 112 is configured to receive data from one or more external data sources 141. An external data source 141 refers to hardware and/or software operating independent of the healthcare services platform 112, i.e., under control of a different entity (e.g., a different company or other kind of organization) than an entity that controls the healthcare services platform 112. An external data source 141 may supply data associated with healthcare services, such as medical lab procedures and testing, x-ray procedures, magnetic resonance imaging (MRI) procedures, physical therapy services, expenses associated with food and lodging of a patient at a hospital, rehabilitation services, mental health counseling services, prescription pharmaceutical expenses, and other healthcare services. Many different kinds of external data sources 141 may supply many different kinds of data.

In some embodiments, a healthcare services platform 112 is configured to retrieve data from an external data source 141 by ‘pulling’ the data via an application programming interface (API) of the external data source 141, using user credentials 134 that a user has provided for that particular external data source 141. Alternatively, or additionally, an external data source 141 may be configured to ‘push’ data to the healthcare services platform 112 via an API of the expense reporting service, using an access key, password, and/or other kind of credential that a user has supplied to the external data source 141. A healthcare services platform 112 may be configured to receive data from an external data source 141 in many different ways.

In some embodiments, a reimbursement service 142 refers to hardware and/or software configured to perform operations for reimbursing approved medical claims. For example, the reimbursement service 142 may be part of an insurer that maintains insurance policies for patients, determines which healthcare services qualify for reimbursement, determines an amount that should be reimbursed for a particular healthcare service, and provides a healthcare services provider with a reimbursement based on a medical claim for the healthcare services.

In some embodiments, one or more components of the system 100 implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Generating Recommendations for Modifying Healthcare Services Attributes

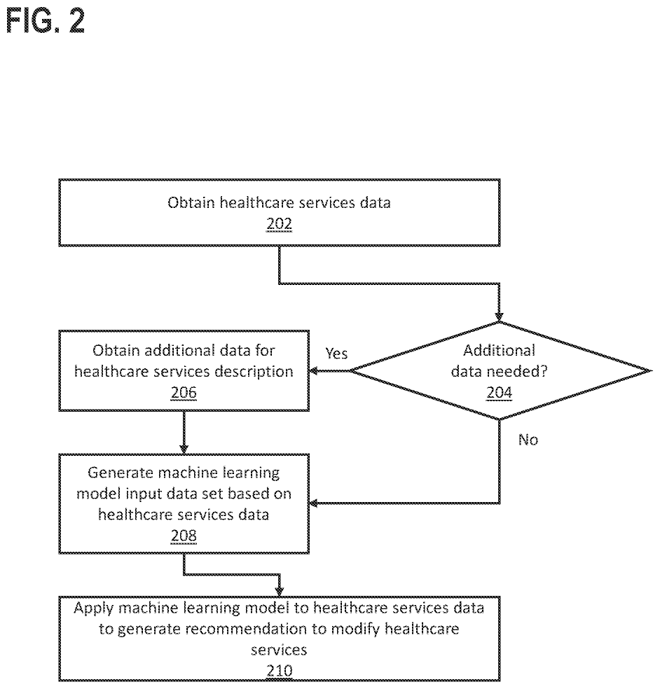

FIG. 2 illustrates an example set of operations for generating recommendations for modifying healthcare services attributes—such as health services performed and/or data recorded to describe or claim health services—in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In some embodiments, a system (e.g., one or more components of system 100 illustrated in FIG. 1) obtains healthcare services data (Operation 202). In some cases, the healthcare services data, referenced in operation 202, is obtained prior to generation of any medical claims. For example, a system may obtain healthcare services data in real-time, as healthcare providers generate perform healthcare services and/or record data associated with the healthcare services provided. In addition, or alternatively, the system may obtain a set of healthcare services data stored in a data repository. For example, a set of healthcare services data may be flagged for analysis to provide recommendations for modifying the healthcare services data based on one or more criteria, such as a source of the healthcare services data, a type of healthcare services, a date and/or time when a healthcare service was provided, an insurer associated with the healthcare services, and data recorded in a medical claim associated with the healthcare services. In addition, or in the alternative, the system may analyze sets of claims at regular intervals. For example, a system may obtain a batch of medical claims, prior to sending the medical claims to reimbursement entities, on a particular day or in a particular week.

In some embodiments, the system obtains a set of healthcare services data to provide to a machine learning model for generating a recommendation for modifying healthcare services data by comparing the healthcare services data with a healthcare services modification trigger. As discussed above, a healthcare services modification trigger is a codified set of rules and/or automatically learned patterns that capture one or more conditions for applying a machine learning model to healthcare services data to generate predictions for reimbursement values and recommendations for modifying healthcare services and/or healthcare services data. Healthcare services identified by a healthcare services modification trigger may include healthcare services provided on a particular date beyond a threshold date, particular types of healthcare services, a particular type of healthcare provider (such as doctor, a medical assistant, or a specialist, such as an anesthesiologist), or a claim directed to a particular insurer.

In some embodiments, the system applies the machine learning model to healthcare services data that is not used to generate a medical claim, or that is not included in a medical claim. Examples of information collected by a healthcare provider that may not be used to generate a medical claim, or that is not included in a medical claim, includes: sensitive information, such as information about a patient's mental health, sexual history, substance abuse, or family physical or mental health history; genetic test results; psychotherapy notes; and diagnoses associated with sensitive information. According to one example, a physician may obtain genetic testing data associated with a patient indicating a predisposition for a particular medical condition. The genetic testing data may influence the physician's choice between two treatment options for the patient. The physician may record the genetic testing data in a record associated with the patient. However, the healthcare services provider that generates medical claims on behalf of the physician may refrain from including the genetic testing data in any medical claim. The system may apply the machine learning model to a set of healthcare services data including the genetic testing data that is not included in any medical claim to an insurer. According to one embodiment, the machine learning model generates a prediction for reimbursement values associated with medical services using data that is not used to generate a medical claim for reimbursement. According to one embodiment, the machine learning model generates a recommendation to modify healthcare services attributes associated with the patient to perform one or both of: (a) including particular information in a medical claim that does not disclose the genetic testing data to improve a reimbursement outcome, or (b) modify a treatment plan for the patient based on the genetic testing data to improve the reimbursement outcome. For example, the physician may have an option to select between two drugs for prescribing to the patient based on the genetic testing data. The machine learning model may recommend prescribing a drug associated with a higher reimbursement rate.

In some embodiments, the system determines whether additional data is needed (Operation 204). Specifically, the system may determine that not enough information is available to generate a set of input data for a machine learning model. As one example, a single description associated with a performed healthcare service recorded in a healthcare service records system may be associated with a range of dates (e.g., “January 21-January 23”). The system may determine that analysis of the healthcare service requires the range of dates to be broken down into separate entries for each day. As another example, a single entry of a healthcare service may include multiple healthcare services (e.g., “administered drug X and administered drug Y”). The system may determine that analysis of the healthcare service requires separate entries for each healthcare service provided. Additional examples of data which may be needed include: healthcare services which were provided but not described in a medical claim, healthcare providers (e.g., doctors or nurses) who participated in providing medical services who are not identified in records associated with the healthcare services, and a date on which a healthcare service was provided.

In some embodiments, if additional data is needed, the system obtains additional data for the healthcare service (Operation 206). The system may present, in a graphical user interface, a message to the employee requesting the additional data. Responsive to the message, the employee may supply the requested data.

In some embodiments, the system generates a set of input data to which the system may apply a machine learning model (Operation 208). For example, the system may identify a set of data elements for each healthcare service, such as: facility type (e.g., hospital, clinic, lab), care type (e.g., emergency, urgent care, intensive care, long-term care, testing services, regularly-scheduled check-up), physician, additional medical personnel, medical service(s) provided, date(s) of medical service(s), drugs administered, prescriptions generated, diagnoses provided, patient identification information, insurer identification information, and insurance plan information. The system may convert the input data into a format ingestible by a machine learning model to generate predictions and/or recommendations. For example, the system may convert text values into numerical representations. The system may convert text and/or numerical values into vector-type values.

One or more embodiments generate predictions for reimbursement values and/or recommendations for modifying healthcare services based on input data including one or more stages of healthcare services. For example, a healthcare services platform generates a reimbursement request, including medical codes and a list of services for which the healthcare services provider is requesting reimbursement, once services have been provided. A system may collect as input data for a machine learning model all of (a) data obtained from a patient during an intake process, (b) data obtained from one or both of the patient and a healthcare provider during a diagnosis/treatment process, (c) coding data, (d) charge data, and (e) reimbursement request data (such as a list of medical services and corresponding charges as they would appear on a reimbursement request). In addition, one or more embodiments receive as input data to a machine learning model any subset of (a)-(e). For example, a system may obtain from a machine learning model an initial reimbursement prediction or recommendation for modifying healthcare services based on only (a), data obtained from a patient during an intake process. For example, a model may learn that for a particular insurer, a particular patient, and a particular set of symptoms (independent of any provided services), a healthcare services provider is likely to be reimbursed at a particular limit. The model may further recommend, for the particular insurer and set of symptoms, a particular type of diagnostic service that corresponds to in increased reimbursement amount. Alternatively, a system may provide data corresponding to (a) and (b), (a)-(c), or (a)-(d) to a machine learning model to obtain a prediction and/or recommendation for modifying healthcare services.

The system applies a machine learning model to the input data set to generate recommendation for modifying healthcare services (Operation 210). For example, based on a provided set of input data associated with a reimbursement request, prior to sending the request to an insurer, the system may predict a reimbursement value less than the claim value included in the reimbursement request, indicating an insurer is unlikely to provide a reimbursement for the requested value. The system may identify one or more healthcare services attributes that would likely increase an estimated reimbursement. The system may accordingly provide a recommendation for modifying the one or more healthcare services attributes.

According to one or more embodiments, providing the input data to the machine learning model includes providing the input data to both a machine learning model for predicting a reimbursement value associated with provided healthcare services and providing the input data to an explainer model to generate an explanation for a particular prediction. The explainer model may identify, from among a set of input data features provided to the machine learning model, the particular features having the greatest influence on the prediction. For example, the explainer model may identify the features: “charge amount,” “medical code,” and “payer name” as the three input data features having the greatest influence on the prediction that a reimbursement amount will be less than a charge. An example of an explainer-type model is a SHAP (Shapley Additive Explanations) type model.

Based at least on the predicted reimbursement value and the identification of input features having the greatest influence on the prediction, the machine learning model generates a recommendation for modifying medical services attributes, such as: healthcare services provided, descriptions of healthcare services recorded in a data repository, and data associated with healthcare services included in a medical claim to be sent to reimbursement entities. According to one embodiment, the recommendation for modifying the healthcare service attributes is encoded in an output layer of the machine learning model. For example, the output from the machine learning model may identify one or more classification labels associated with modifications, such as: add a medical services code, remove a medical services code, assign a particular priority level, adjust a monetary value associated with the healthcare service, combine two or more listed services into one entry, or separate two or more services into separate entries.

According to one example, the recommendation for modifying healthcare service attributes includes assigning a priority label to a healthcare service. Among a set of healthcare services, a healthcare provider may choose to pursue medical claims for healthcare services associated with a higher priority level, which may be associated with one or more of: a higher reimbursement level or percentage, a higher likelihood that a medical claim will be reimbursed, a likelihood that a patient will be able to pay for a particular medical expense denied by an insurer, a particular type or class of medical service, and an estimated time by which an insurer and/or patient will provide a reimbursement for a medical claim.

According to one example, the recommendation for modifying healthcare service attributes includes identifying a modification to a medical code associated with a healthcare service or drug described in a record associated with the healthcare service. For example, one healthcare service may be associated with two or more medical codes. The recommendation may include: adding to a healthcare service record a medical code that was not included in the healthcare service record, or omitting from the healthcare service record a medical code that was included in the healthcare service record. As another example, a medical code associated with a healthcare service or drug in a healthcare service record may be incorrect. The recommendation may include replacing a medical code with another medical code.

According to another example, the recommendation for modifying healthcare service attributes includes modifying verbiage describing a healthcare service. The machine learning model may identify particular sets of words associated with particular healthcare services that are related to reimbursement amounts from reimbursement entities (e.g., insurers or patients). Accordingly, the machine learning model may recommend using certain words in medical claims associated with particular healthcare services.

According to another example, the recommendation for modifying healthcare service attributes includes modifying a charge amount associated with a healthcare service. For example, a healthcare provider may charge a fixed amount for a particular service, and a healthcare service record may show an amount less than the fixed amount. Accordingly, the machine learning model may recommend increasing the recorded charge amount associated with the healthcare service to obtain a higher reimbursement amount. Alternatively, a reimbursement entity (e.g., an insurer or a patient) may be more likely to reimburse a medical service provider for a medical claim associated with a smaller amount for a particular healthcare service. Accordingly, the machine learning model may generate a recommendation to decrease the charge amount associated with a particular healthcare service in a healthcare service record used to generate medical claims to increase a likelihood that a reimbursement entity will provide a reimbursement.

The system modifies one or more requests for reimbursement for healthcare services based on the recommendation generated by the machine learning model. The system provides the requests for reimbursement to a reimbursement provider, such as an insurance company.

One or more embodiments include a single machine learning model to receive input data and to generate a recommendation for modifying medical services. Accordingly, the reimbursement prediction and the explainer-type feature may be inherent in hidden layers of the machine learning model. According to an alternative embodiment, a system provides an input data set to a reimbursement-prediction-type machine learning model and an explainer-type model to generate (a) a reimbursement prediction value, and (b) an explanation of input features that have the greatest influence on the reimbursement prediction value. The system may then provide one or both of (a) and (b) to a healthcare services modification recommendation-type machine learning model to generate a recommendation for modifying medical services attributes, such as services provided and data included in a reimbursement request.

### 4. Integrating Machine Learning into Modifications to Healthcare Services

In some embodiments, the healthcare services platform 112 leverages machine learning to facilitate and automate processes for handling expense data. Machine learning allows healthcare services platform 112 to perform tasks and capture patterns that are not hard-coded or otherwise explicitly programmed into the system. Machine learning further allows healthcare services platform 112 to adapt to different application use-cases and evolve over time without requiring complex reprograming or other changes in the underlying application code.

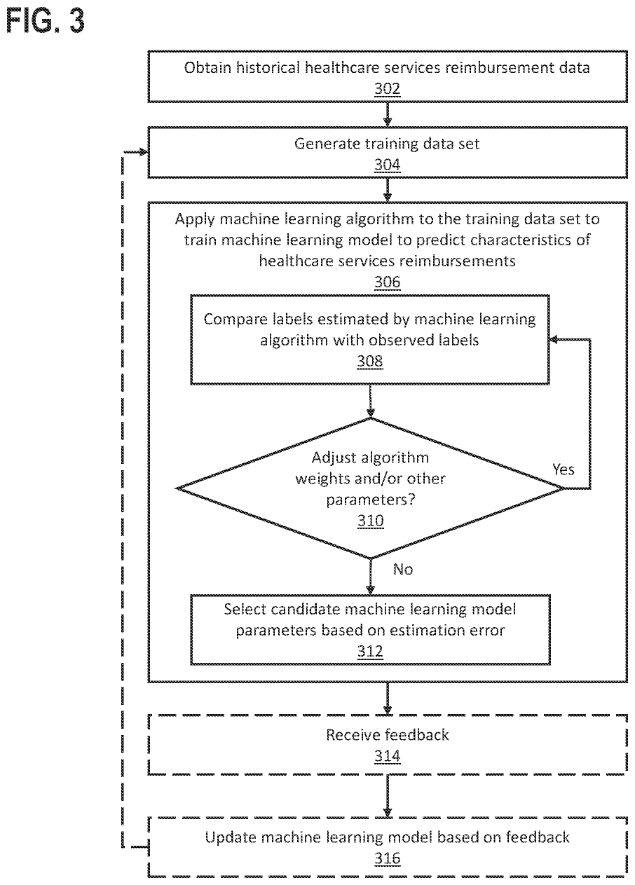

FIG. 3 illustrates an example set of operations for training a machine learning model to estimate unknown labels for expense data in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

In some embodiments, a system (e.g., one or more components of system 100 illustrated in FIG. 1) obtains historical healthcare services reimbursement data (Operation 302). Obtaining the historical healthcare services reimbursement data may include obtaining: healthcare service records, obtaining charges assigned to medical services, obtaining medical claims generated by healthcare services providers based on the medical services, and obtaining data describing reimbursements provided by patients and insurers in response to medical claims. According to one or more embodiments, obtaining the historical healthcare service reimbursement data includes obtaining descriptions in healthcare services records of information that is not included in medical claims provided to reimbursement entities, such as sensitive patient information, mental health information, sexual history information, genetic test information, and family medical history (mental health and physical health) information.

The system uses the historical healthcare services reimbursement data to generate a set of training data (Operation 304). The set of training data includes, for a particular healthcare service record in the historical healthcare services reimbursement data, at least one classification label. For example, the system may identify in the historical data a particular medical claim listing three services and monetary values associated with the services. The system may further identify in the historical data information specifying how much an insurer reimbursed the healthcare provider for the three services. The system may generate three separate labels corresponding to the three separate services. The system may generate additional labels associated with a medical claim, including facility type (e.g., hospital, clinic, lab), care type (e.g., emergency, urgent care, intensive care, long-term care, testing services, regularly-scheduled check-up), physician, additional medical personnel, medical service(s) provided, date(s) of medical service(s), drugs administered, prescriptions generated, diagnoses provided, patient identification information, insurer identification information, and insurance plan information.

According to one embodiment, the system obtains the historical data and the training data set from a data repository storing labeled data sets. The training data set may be generated and updated by a healthcare service provider or organization. Alternatively, the training data set may be generated and maintained by a third party. According to one embodiment, the system generates the labeled set of data by parsing documents and generating labels based on parsed values in the documents. According to an alternative embodiment, one or more users generate labels for a data set.

In some embodiments, generating the training data set includes generating a set of feature vectors for the labeled examples. A feature vector for an example may be n-dimensional, where n represents the number of features in the vector. The number of features that are selected may vary depending on the particular implementation. The features may be curated in a supervised approach or automatically selected from extracted attributes during model training and/or tuning. Example features include information about a healthcare provider that provided a healthcare service to a patient, geographic information about where a healthcare service was provided (e.g., a region or a facility), temporal information about when a service was provided (e.g., date and time), categorical information about what type of healthcare service was provided (e.g., out-patient service, regularly-scheduled check-up, overnight treatment, mental health services, surgical procedures, emergency services), and the cost to provide the healthcare service. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a type of healthcare service has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 306). For example, the machine learning algorithm may analyze the training data set to train neurons of a neural network with particular weights and offsets to associated particular medical claims with particular modification recommendation labels. The particular modification recommendation labels may include identifying particular features in a medical claim and particular modifications associated with the features (such as reducing a requested claim amount, modifying a medical classification code for a medical service, and separating a healthcare service into two or more healthcare services).

In some embodiments, iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the system may generate and train a candidate recurrent neural network model, such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one expense or activity may depend on its position within a sequence of feature vector representations. Thus, the nodes may have a memory to remember relevant temporal dependencies between different medical claims. For example, a medical claim in isolation may have a first set of weights applied by nodes as a function of the respective feature vector for the expense. However, if the medical claim is immediately preceded by another type of medical claim associated with the same patient, then a different set of weights may be applied by one or more nodes based on the memory of the preceding medical claim. In this case, a reimbursement value assigned to the second medical claim may be affected by the first medical claim. As another example, one or more nodes may apply different weights if a medical claim is unique or a duplicate of another medical claim on the same day. In this case, the trained machine learning model may automatically filter out and reject duplicate medical claims made on the same day while recurring healthcare services (e.g., monthly visits to an oncologist to monitor a treatment regimen) may be permitted. Additionally, or alternatively, the system may generate and train other candidate models, such as support vector machines, decision trees, Bayes classifiers, and/or fuzzy logic models, as previously described.

In some embodiments, the system compares the labels estimated through the one or more iterations of the machine learning model algorithm with observed labels to determine an estimation error (Operation 308). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error (Operation 310). Adjustments may be made until a candidate model that minimizes the estimation error or otherwise achieves a threshold level of estimation error is identified. The process may return to Operation 308 to make adjustments and continue training the machine learning model.

In some embodiments, the system selects machine learning model parameters based on the estimation error meeting a threshold accuracy level (Operation 312). For example, the system may select a set of parameter values for a machine learning model based on determining that the trained model has an accuracy level for predicting labels for medical claims of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of related medical claims. Each medical claim may be processed as a separate discrete instance of time. For instance, an example may include medical claims c₁, c₂, and c₃ corresponding to times t, t+1, and t+2, respectively. Backpropagation through time may perform adjustments through gradient descent starting at time t+2 and moving backward in time to t+1 and then to t. Further, the backpropagation process may adjust the memory parameters of a cell such that a cell remembers contributions from previous expenses in the sequence of expenses. For example, a cell computing a contribution for e₃ may have a memory of the contribution of e₂, which has a memory of e₁. The memory may serve as a feedback connection such that the output of a cell at one time (e.g., t) is used as an input to the next time in the sequence (e.g., t+1). The gradient descent techniques may account for these feedback connections such that the contribution of one medical claim to a cell's output may affect the contribution of the next medical claim in the cell's output. Thus, the contribution of c₁ may affect the contribution of c₂, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of expenses.

In embodiments in which the machine learning algorithm is a supervised machine learning algorithm, the system may optionally obtain feedback on the various aspects of the analysis described above (Operation 314). For example, the feedback may affirm or revise labels generated by the machine learning model. The machine learning model may indicate that a particular medical claims is associated with a label to “reduce monetary amount associated with medical procedure.” The system may receive feedback indicating that the particular medical claim should instead be associated with a label to “modify medical procedure classification identifier.” Based on the feedback, the machine learning training set may be updated, thereby improving its analytical accuracy (Operation 316). Once updated, the system may further train the machine learning model by optionally applying the model to additional training data sets.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

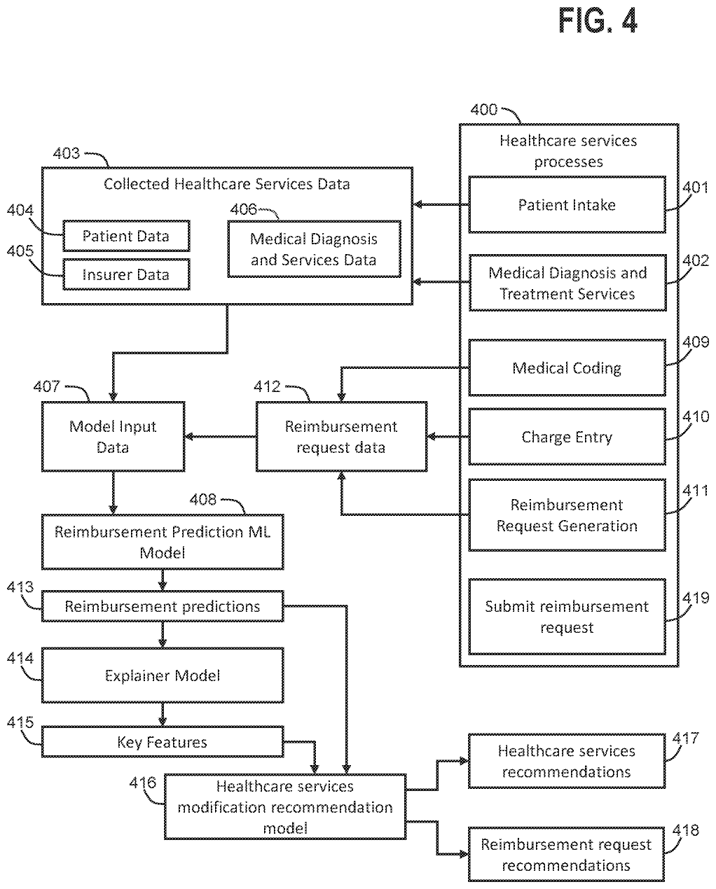

FIG. 4 illustrates an example embodiment of a system for recommending modifications to healthcare services based, in part, on predictions of reimbursement values for the healthcare services.

A healthcare services platform performs a sequence of healthcare services processes 400 in the course of receiving and treating a patient and generating a reimbursement request for healthcare services provided to the patient. The platform obtains healthcare services data 403 from a patient, from a healthcare provider, such as a physician, nurse, or medical assistant, and from data stored in a data repository. For example, during a patient intake process 401, a healthcare services platform obtains patient data 404, such as identification and medical history, and insurer data 405. During a medical diagnosis and treatment process 402, the healthcare services platform obtains diagnosis and services data 406, such as: additional symptoms identified by a physician by lab tests, or in conversation with the patient, a diagnosis by a physician, a course of treatment prescribed and/or performed, including prescription medication prescribed, surgical procedures, or additional tests.

The system provides data obtained from a first patient during a patient intake process 401 as input data 407 to a machine learning model 408. Based on the patient data 404 and insurer data 405 obtained during the patient intake process 401, the reimbursement prediction machine learning model 408 generates a prediction of a reimbursement value associated with the patient. The reimbursement value may be a range of reimbursement values.

The system provides the input data 407 to an explainer model 414 to identify key features 415 in the input data 407 that have the greatest influence on the prediction 413. The system provides the reimbursement prediction 413 and the key features 415 to a healthcare services modification recommendation model 416 to generate one or both of healthcare services recommendations 417 and reimbursement request recommendations 418. For example, the healthcare services modification recommendation model 416 may identify, based on input data obtained solely from a patient intake process 401: (a) a particular lab test associated with a set of symptoms in the patient data 404 that corresponds to a higher reimbursement value, and (b) a particular type of healthcare services provider (such as an RN rather than an MD) who should perform one or more healthcare services to obtain a higher reimbursement from a particular insurer.

The system provides data obtained from a second patient during both a patient intake process 401 and a medical diagnosis and treatment service process 402 to the machine learning model 408. The input data 407 associated with the second patient includes patient data 404 and insurer data 405 obtained during the intake process 401, as well as medical diagnosis data and data associated with a prescription provided by a physician based on the diagnosis. The input data 407 further includes data recorded by a physician about a medical history of the second patient that is not included in any reimbursement request. For example, the healthcare services data 403 may include information obtained from a genetic test indicating a susceptibility of the second patient to a particular disease. Healthcare regulations may prevent the physician from sharing the genetic test information with other parties, such as insurers. However, the information may be used by the machine learning models 408, 414, and 416 to generate predictions and recommendations. Based on the collected healthcare services data 403 for the second patient obtained during the patient intake process 401 and the diagnosis and treatment process 402, the reimbursement prediction machine learning model 408 generates a prediction of a reimbursement value associated with the healthcare services provided to the second patient.

The system provides the input data 407 to an explainer model 414 to identify key features 415 in the input data 407 that have the greatest influence on the prediction 413. The system provides the reimbursement prediction 413 and the key features 415 to a healthcare services modification recommendation model 416 to generate one or both of healthcare services recommendations 417 and reimbursement request recommendations 418. For example, the healthcare services modification recommendation model 416 may identify, based on input data obtained solely from a patient intake process 401 and the medical diagnosis and treatment services process 402: (a) a particular pharmaceutical product that corresponds to a higher reimbursement value, and (b) a particular formatting that should be used in a reimbursement request to obtain a higher reimbursement from a particular insurer. For example, the particular formatting may include dividing a particular treatment into two separate sub-treatments associated with two different reimbursement claims.

The system provides data obtained from a third patient during a patient intake process 401 and data obtained from the patient and healthcare providers during a medical diagnosis and treatment service process 402, and from a stored reimbursement request, to the machine learning model 408. The stored reimbursement request includes a set of healthcare procedures associated with treatment of the third patient. The set of procedures is divided into separate lines in the reimbursement request, each associated with a separate charge. For example, examining a patient may correspond to one line and one corresponding charge. Performing a test corresponds to another line and another corresponding charge. Issuing a prescription corresponds to another line and another corresponding charge. The input data 407 associated with the third patient includes patient data 404 and insurer data 405 obtained during the intake process 401, as well as medical diagnosis data and data associated with a surgical procedure performed by a physician based on the diagnosis. The input data 407 further includes reimbursement request data 412. The reimbursement request data 412 includes medical coding data obtained from a medical coding process 409 to associate particular codes to particular medical procedures, charge entry data obtained from a charge entry process 410 to associate particular monetary values to the particular medical procedures, and reimbursement request data, such as text descriptions and formatting of content in a reimbursement request, obtained from a reimbursement request generation process 411. Based on the collected healthcare services data 403 and reimbursement request data 412 for the third patient, the reimbursement prediction machine learning model 408 generates a prediction of a reimbursement value associated with the healthcare services provided to the third patient.

The system provides the input data 407 to an explainer model 414 to identify key features 415 in the input data 407 that have the greatest influence on the prediction 413. The system provides the reimbursement prediction 413 and the key features 415 to a healthcare services modification recommendation model 416 to generate one or both of healthcare services recommendations 417 and reimbursement request recommendations 418. For example, the healthcare services modification recommendation model 416 may identify, based on input data obtained from all of the processes 401, 402, 409, 410, and 411 a particular formatting that should be used in a reimbursement request to obtain a higher reimbursement from a particular insurer. For example, the particular formatting may include modifying a medical code associated with a particular treatment. Another recommendation may be to include in the reimbursement request information which was previously omitted from the request.

The system may be configured to modify one or more healthcare processes without user intervention. For example, the system may determine that a reimbursement request may be modified without user intervention when the modification includes modifying a format of items already included in a reimbursement request. As another example, the system may determine that a reimbursement request may be modified without user intervention when the modification includes modifying a charge associated with a healthcare service by an amount less than a threshold, such as 10%. Other modifications to healthcare services processes may require user intervention, including modifying tests, prescriptions, treatment, and medical codes associated with patient services. In these cases, the system may generate a notification via a user interface device to a healthcare services provider. The healthcare services provider may determine whether to modify the healthcare services according to the recommendation.

Upon modifying the healthcare services, including modifying the reimbursement request, the system submits the reimbursement request to a reimbursement entity 419, including an insurer and a patient.

As noted above, although the example embodiment illustrated in FIG. 4 implements a reimbursement prediction machine learning model 408 to generate a prediction for reimbursement values associated with healthcare services, an explainer model to identify key features contributing to a reimbursement prediction, and a healthcare services modification recommendation model to generate recommendations for modifying one or more attributes of healthcare services, an alternative embodiment implements the models as a single model. For example, a system may train a machine learning model with a data set describing healthcare services and corresponding reimbursement values. The model may learn which features associated with the healthcare services have the greatest impact on reimbursements for healthcare services. The correlations between features and reimbursements may be captured in hidden layers of the machine learning model. The model may generate as output data one or more recommendations for modifying healthcare services attributes to increase reimbursement values associated with the healthcare services.

### 6. Hardware Overview

According to one embodiment, the techniques described herein are implemented by one or more special-purpose computing devices (i.e., computing devices specially configured to perform certain functionality). The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

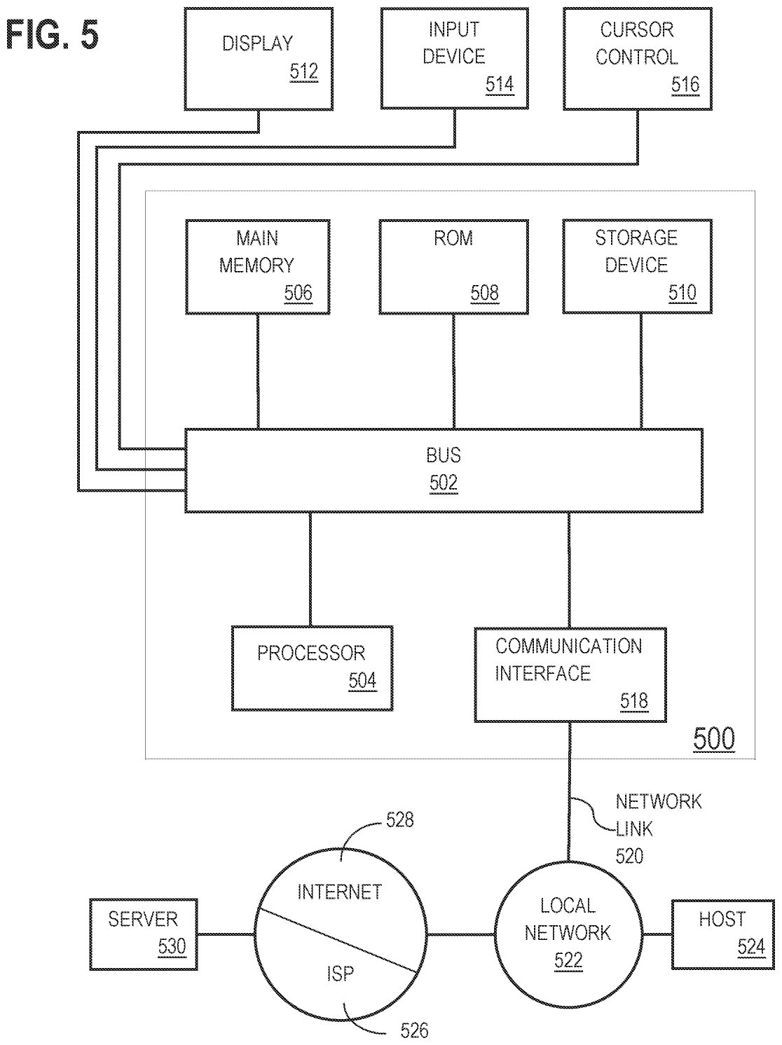

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), plasma display, electronic ink display, cathode ray tube (CRT) monitor, or any other kind of device for displaying information to a computer user. An input device 514, including alphanumeric and other keys, may be coupled to bus 502 for communicating information and command selections to processor 504. Alternatively, or in addition, the computer system 500 may receive user input via a cursor control 516, such as a mouse, a trackball, a trackpad, a touchscreen, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. The display 512 may be configured to receive user input via one or more pressure-sensitive sensors, multi-touch sensors, and/or gesture sensors. Alternatively, or in addition, the computer system 500 may receive user input via a microphone, video camera, and/or some other kind of user input device (not shown).

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a programmable read-only memory (PROM), and erasable PROM (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a network, via a network interface controller (NIC), such as an Ethernet controller or Wi-Fi controller. A NIC local to computer system 500 can receive the data from the network and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 7. Computer Networks and Cloud Networks

In one or more embodiments, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, one tenant (through operation, tenant-specific practices, employees, and/or identification to the external world) may be separate from another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using Hypertext Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
training a machine learning model to predict characteristics of healthcare reimbursements for healthcare services for patients, the training comprising:
obtaining a first training data set of a plurality of training data sets, the first training data set including:
a first set of attributes corresponding to a first healthcare service for a first patient; and
a first reimbursement amount approved for the first healthcare service;
obtaining a second training data set of a plurality of training data sets, the second training data set including:
a second set of attributes corresponding to a second healthcare service for a second patient; and
a second reimbursement amount approved for the first healthcare service;
training the machine learning model using the plurality of training data sets to generate a trained machine learning model;
obtaining a target set of attributes corresponding to a target healthcare service for a particular patient; and
applying the trained machine learning model to the target healthcare service to estimate characteristics of a predicted reimbursement for the target healthcare service.

2. The non-transitory computer readable medium of claim 1, wherein the operations further comprise:
obtaining data identifying an actual reimbursement for the target healthcare service; and
updating the trained machine learning model based on the actual reimbursement.

3. The non-transitory computer readable medium of claim 1, wherein the operations further comprise:
applying the trained machine learning model to a plurality of target healthcare services to estimate characteristics of respective predicted reimbursements for the plurality of target healthcare services; and
prioritizing the plurality of target healthcare services for billing actions to be executed by users.

4. The non-transitory computer readable medium of claim 1, wherein applying the trained machine learning model to the target healthcare service comprises applying the trained machine learning model to reimbursement submission data for requesting a reimbursement for the target healthcare service.

5. The non-transitory computer readable medium of claim 4, wherein the operations further comprise generating a recommendation for modifying the reimbursement submission data based on the characteristics of the predicted reimbursement for the target healthcare service.

6. The non-transitory computer readable medium of claim 5, wherein the reimbursement submission data comprises vendor-agnostic data.

7. The non-transitory computer readable medium of claim 1, wherein the characteristics of the predicted reimbursement comprise a reimbursement amount for the target healthcare service.

8. The non-transitory computer readable medium of claim 1, wherein the characteristics of the predicted reimbursement comprise a predicted time of payment for at least a portion of a reimbursement for the target healthcare service.

9. The non-transitory computer readable medium of claim 1, wherein the predicted characteristics of the reimbursement comprise a reimbursement percentage of an amount billed for the target healthcare service.

10. The non-transitory computer readable medium of claim 1, wherein the first set of attributes corresponding to the first healthcare service comprise one or more of:
a healthcare service code corresponding to the first healthcare service;
a type of the first healthcare service;
an age of the first patient;
an ordering provider that provided the first healthcare service;
a drug code for a drug administered during the first healthcare service; and
a monetary value representing a requested reimbursement amount associated with the first healthcare service.

11. The non-transitory computer readable medium of claim 1, wherein the first training data set further comprises a payer that approved the first reimbursement amount.

12. The non-transitory computer readable medium of claim 1, wherein the first training data set comprises a data of a data type that is not used for generating medical claims.

13. A method comprising:
training a machine learning model to predict characteristics of healthcare reimbursements for healthcare services for patients, the training comprising:
obtaining a first training data set of a plurality of training data sets, the first training data set including:
a first set of attributes corresponding to a first healthcare service for a first patient; and
a first reimbursement amount approved for the first healthcare service;
obtaining a second training data set of a plurality of training data sets, the second training data set including:
a second set of attributes corresponding to a second healthcare service for a second patient; and
a second reimbursement amount approved for the first healthcare service;
training the machine learning model using the plurality of training data sets to generate a trained machine learning model;
obtaining a target set of attributes corresponding to a target healthcare service for a particular patient; and
applying the trained machine learning model to the target healthcare service to estimate characteristics of a predicted reimbursement for the target healthcare service.

14. The method of claim 13, further comprising:
obtaining data identifying an actual reimbursement for the target healthcare service; and
updating the trained machine learning model based on the actual reimbursement.

15. The method of claim 13, further comprising:
applying the trained machine learning model to a plurality of target healthcare services to estimate characteristics of respective predicted reimbursements for the plurality of target healthcare services; and
prioritizing the plurality of target healthcare services for billing actions to be executed by users.

16. The method of claim 13, wherein applying the trained machine learning model to the target healthcare service comprises applying the trained machine learning model to reimbursement submission data for requesting a reimbursement for the target healthcare service.

17. The method of claim 16, further comprising:
generating a recommendation for modifying the reimbursement submission data based on the characteristics of the predicted reimbursement for the target healthcare service.

18. The method of claim 17, wherein the reimbursement submission data comprises vendor-agnostic data.

19. The method of claim 13, wherein the characteristics of the predicted reimbursement comprise a reimbursement amount for the target healthcare service.

20. A system comprising:
one or more processors; and
memory storing instructions that, when executed by the one or more processors, cause the system to perform operations comprising:
training a machine learning model to predict characteristics of healthcare reimbursements for healthcare services for patients, the training comprising:
obtaining a first training data set of a plurality of training data sets, the first training data set including:
a first set of attributes corresponding to a first healthcare service for a first patient; and
a first reimbursement amount approved for the first healthcare service;
obtaining a second training data set of a plurality of training data sets, the second training data set including:
a second set of attributes corresponding to a second healthcare service for a second patient; and
a second reimbursement amount approved for the first healthcare service;
training the machine learning model using the plurality of training data sets to generate a trained machine learning model;
obtaining a target set of attributes corresponding to a target healthcare service for a particular patient; and
applying the trained machine learning model to the target healthcare service to estimate characteristics of a predicted reimbursement for the target healthcare service.
